(19) United States
(12) Patent Application Publication
(10) Pub. No.: US 2008/0170116 A1
(43) Pub. Date: Jul. 17, 2008

(54) Image generating apparatus, communication system and communication method

(75) Inventors: Yasuyuki Nishibayashi, Kawasaki-shi (JP); Shinya Murai, Kawasaki-shi (JP); Masataka Goto, Yokohama-shi (JP); Kensaku Yamaguchi, Yokohama-shi (JP); Hiroshi Kawazoe, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/819,656

(22) Filed: Jun. 28, 2007

(30) Foreign Application Priority Data
Jan. 15, 2007 (JP) P2007-005313

(51) Int. Cl. H04N 7/14

(52) U.S. Cl. 348/14.02; 348/E07.077

(57) ABSTRACT

An image generating apparatus includes: an image generating unit configured to generate and update an image to be displayed by a remote display terminal, the remote display terminal including a radio communication unit whose power state is switchable; an update detection unit configured to detect an update of the image by the image generating unit; a first transmission control unit configured to control transmission of the image,whose update is detected by the update detection unit, toward the radio communication unit of the remote display terminal; a switching decision unit configured to decide switching of the power state of the radio communication unit if the update detection unit does not detect the update of the image for a predetermined period; a message generating unit configured to generate a message to order switching of the power state of the radio communication unit of the remote display terminal based on a decision by the switching decision unit; and a second transmission control unit configured to control transmission of the message generated by the message generating unit to the radio communication unit of the remote display terminal.

### CROSS-REFERENCE TO RELATED APPLICATIONS

This application is based upon and claims the benefit of priority from the prior Japanese Patent Application No. 2007-005313, filed on Jan. 15, 2007; the entire contents of which are incorporated herein by reference.

### BACKGROUND OF THE INVENTION

1. Field of the Invention

The present invention relates to an image generating apparatus, a communication system and a communication method for transmitting/receiving an image.

2. Description of the Related Art

There is disclosed a technology of a computing system in which a display terminal and a main apparatus (personal computer, server computer and the like) connected to this display terminal via a network are combined (for example, see U.S. Pat. No. 6,784,855). Input information (pen inputting by a digitizer and the like) is transmitted from the display terminal to the main apparatus and processed. Screen information based on a processing result thereof is transmitted from the main apparatus to the display terminal and displayed. In this computing system, since a processing capability of the display terminal is not required, architecture of the display terminal can be simple and carriageable for the sake of user's convenience.

There is also disclosed a wireless display system constituted with a computer and a wireless display which are capable of wirelessly communicating with each other, and the wireless display automatically returns from in a power-saving operation mode into a normal operation mode (for example, see JP-A2002-323942 (KOKAI)).

### SUMMARY OF THE INVENTION

An image generating apparatus according to a mode of the present invention includes: an image generating unit configured to generate and update an image to be displayed by a remote display terminal, the remote display terminal including a radio communication unit whose power state is switchable; an update detection unit configured to detect an update of the image by the image generating unit; a first transmission control unit configured to control transmission of the image,whose update is detected by the update detection unit, toward the radio communication unit of the remote display terminal; a switching decision unit configured to decide switching of the power state of the radio communication unit if the update detection unit does not detect the update of the image for a predetermined period; a message generating unit configured to generate a message to order switching of the power state of the radio communication unit of the remote display terminal based on a decision by the switching decision unit; and a second transmission control unit configured to control transmission of the message generated by the message generating unit to the radio communication unit of the remote display terminal.

A communication system according to a mode of the present invention having a remote display terminal and an image generating apparatus, the remote display terminal including: an input unit configured to input information, a radio communication unit having a transmission part configured to transmit information inputted by the input unit to the apparatus and a receiving part configured to receive an image from the apparatus, a power state of the radio communication unit configured to be switchable, a display unit configured to display the image received by the receiving part, and a first switching unit configured to switch the power state of the radio communication unit based on an input by the input unit; the apparatus including: an image generating unit configured to generate and update an image to be displayed by the remote display terminal, an update detection unit configured to detect an update of the image by the image generating unit, a first transmission control unit configured to control transmission of the image whose update is detected by the update detection unit, toward the radio communication unit of the remote display terminal, a switching decision unit configured to decide switching of the power sate of the radio communication unit if the update detection unit does not detect the update of the image for a predetermined period, a message generating unit configured to generate a message to order the switching of the power state of the radio communication unit of the remote display terminal based on a decision by the switching decision unit, and a second transmission control unit configured to control transmission of the message generated by the message generating unit to the radio communication unit of the remote display terminal.

A communication method according to a mode of the present invention includes the steps of: detecting an update of an image generated by an image generating unit; transmitting the image whose update is detected to a radio communication unit of a remote display terminal; deciding switching of a power state of the radio communication unit of the remote display terminal if the update of the image is not detected for a predetermined period; generating a message to order the switching of the power state of the radio communication unit based on the decision; and transmitting the generated message to the radio communication unit.

### BRIEF DESCRIPTION OF THE DRAWINGS

FIG. 1 is a block diagram showing a screen transfer system according to an embodiment of the present invention.

FIG. 2 is a block diagram showing an internal configuration of an image generating apparatus.

FIG. 3 is a schematic diagram showing an example of a power-saving state shift message.

FIG. 4 is a schematic diagram showing another example of the power-saving state shift message.

FIG. 5 is a block diagram showing an internal configuration of an access point.

FIG. 6 is a block diagram showing an internal configuration of a display terminal.

FIG. 7 is a schematic diagram showing an example of an operating state of the display terminal in a power save mode;

FIG. 8 is a schematic diagram showing a configuration of a MAC frame.

FIG. 9 is a flowchart showing an outline of operating procedures of the screen transfer system.

FIG. 10 is a sequence diagram showing an example of a flow of a signal in the screen transfer system.

FIG. 11 is a flowchart showing an example of operating procedures in the display terminal.

FIG. 12 is a flowchart showing an example of operating procedures in the image generating apparatus.

FIG. 13 is a flowchart showing another example of the operating procedures in the image generating apparatus.

FIG. 14 is a timing chart showing an example of a timing of a processing in the image generating apparatus.

FIG. 15 is a timing chart showing an example of a timing of a processing in the image generating apparatus.

FIG. 16 is a timing chart showing an example of a timing of a processing in the image generating apparatus.

FIG. 17 is a flowchart showing an example of operating procedures in an access point A.

### DESCRIPTION OF THE EMBODIMENTS

Hereinafter, embodiments of the present invention will be described with reference to the drawings.

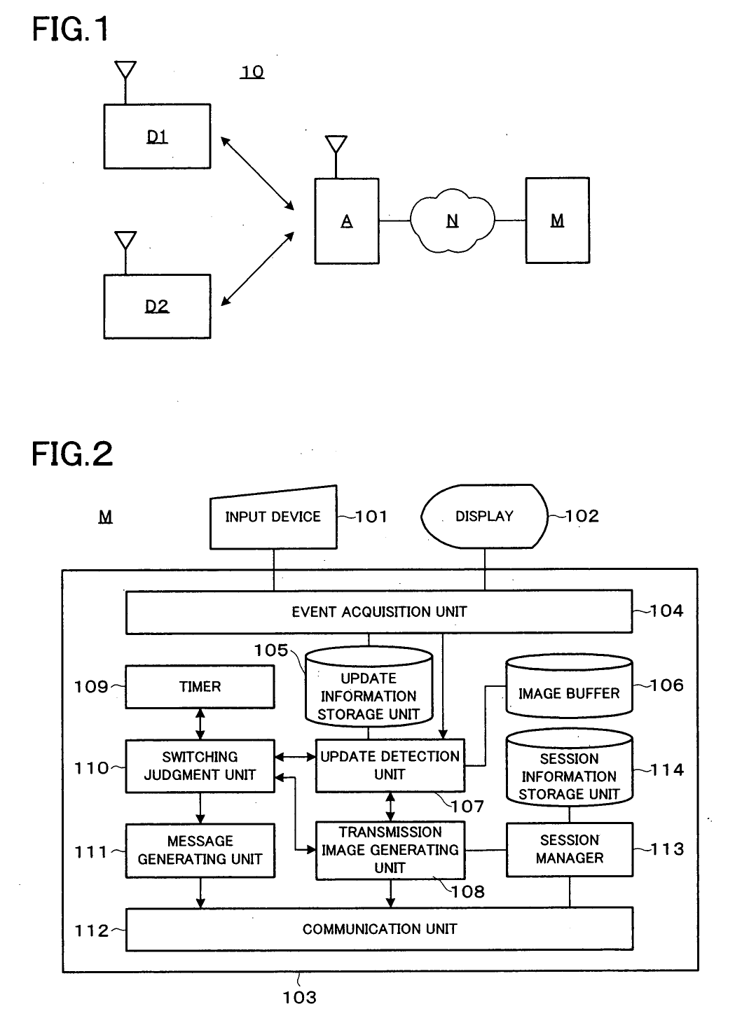

FIG. 1 is a block diagram showing a screen transfer system 10 according to an embodiment of the present invention. The screen transfer system 10 includes an image generating apparatus M, an access point A,and display terminals D1, D2. The image generating apparatus M communicates with the display terminals D1, D2 via the access point A. The access point A is connected to the image generating apparatus M via a network N and communicates with the display terminals D1, D2 by radio.

The screen transfer system 10 has a so-called screen sharing function. In other words, an image of a screen is generated by the image generating device M and displayed on the display terminals D1, D2. The image of the screen is updated by the image generating apparatus M, transmitted to the display terminals D1, D2 and displayed, in real time.

### (Details of Image Generating Apparatus)

The image generating apparatus M performs application programs for each of the display terminals D1, D2 (application processing). As a result, if a change occurs in the screen, difference information of the update screen is subjected to still image compression and transmitted to the display terminals D1, D2 as difference image information U. In order to secure real-timeness, updated part of image data (difference image information U) is transmitted.

FIG. 2 is a block diagram showing an internal configuration of the image generating apparatus M. The image generating apparatus M includes an input device 101, a display 102, and an apparatus main body 103. The apparatus main body 103 has an event acquisition unit 104, an update information storage unit 105, an image buffer 106, an update detection unit 107, a transmission image generating unit 108, a timer 109, a switching judgment unit 110, a message generating unit 111, a communication unit 112, a session manager 113, and a session information storage unit 114.

This image generating apparatus M can be realized by a combination of hardware and software. As the hardware, there can be used a computer constituted with a central processing unit (hereinafter referred to as “CPU”), a memory, a hard disk device and the like. Incidentally, the software can be loaded from the outside of the image generating apparatus M by communication.

The input device 101 is an information input means such as a mouse, a keyboard, a trackball and the like, and can perform a moving operation to a cursor displayed on a screen of the display 102, for example.

The display 102 is a display means such as a CRT and a liquid crystal display device.

The event acquisition unit 104 can be realized by an operating system (hereinafter, referred to as “OS”), a virtual display driver, a frame buffer, and an application program. The OS is software to integratedly control the computer. The virtual display driver is software having a function equal to that of a display driver incorporated in this OS. The frame buffer is a temporary storage area for image drawing. The application program is application software operating on the OS.

The event acquisition unit 104 generates image data to be displayed on the display terminals D1, D2 according to an event generated by an operation of the application program. More specifically, the event acquisition unit 104 generates an update image and stores information (update information) related to this update image in the update information storage unit 105. When the screen is updated by the application software or when the cursor is subjected to the moving operation by a mouse operation and the like and an image in any area in the screen is updated, the update image is generated. The virtual display driver acquires a draw command from a graphic engine of the OS and performs a drawing processing, and whereby the update image is generated.

The update information storage unit 105 temporarily stores the update information in a queue (first-in, first-out). This update information indicates that the image is updated. As the update information, there can be used update image information (information of an update image itself) or drawing area information (information indicating a coordinate area on the screen on which the update image is disposed).

The image buffer 106 is a temporary storage device for storing the update image information acquired by the update detection unit 107.

The update detection unit 107 detects an update of the image based on the update information in the update information storage unit 105 and calculates a difference between the images before and after the update. In other words, the update detection unit 107 functions as the update detection unit detecting the update of the image and as a difference generating unit generating difference information between the images before and after the update.

The update detection unit 107 acquires the update image based on the update information. If the update information in the update information storage unit 105 is the update image information, the update detection unit 107 acquires the update image information from the update information storage unit 105. If the update information in the update information storage unit 105 is the drawing area information, the update detection unit 107 acquires the update image information from the frame buffer in the event acquisition unit 104. The update image information acquired as above is sequentially outputted to the image buffer 106.

The update detection unit 107 generates a difference (difference image information) between the old and the new update images sequentially held by the image buffer 106. In other words, the update detection unit 107 calculates the difference between the new image data generated by the event acquisition unit 104 and the image data buffered in the image buffer 106. The calculated difference image information is outputted to the transmission image generating unit 108.

The transmission image generating unit 108 generates transmission image data by subjecting the difference image information calculated by the update detection unit 107 to still image compression. Incidentally, for the still image compression, both a lossy compression method such as JPEG (Joint Photographic Experts) and a lossless compression method can be used.

Further, the transmission image generating unit 108 notifies the switching judgment unit 110 of start or completion of generation just before the generation and immediately after the generation of the transmission image data.

Incidentally, the update detection unit 107 and the transmission image generating unit 108 can be realized by screen transfer application software and the like.

The timer 109 is a time keeping means for keeping time. As will be described later, the timer 109 is used for judgment in the switching judgment unit 110.

The switching judgment unit 110 judges necessity of switching of a radio power-saving control mode in compliance with an IEEE802.11 standard of the display terminals D1, D2. In other words, the switching judgment unit 110 functions as a switching decision unit deciding switching of a power state. As will be described later, radio communication units 135 of the display terminals D1, D2 have two modes of an active mode (normal state) and a power save mode (power-saving state). In the active mode, while communication ability of the radio communication unit 135 is not limited, power consumption is large. In the power save mode, while the communication ability of the radio communication unit 135 is limited, the power consumption is small. In other words, the switching judgment unit 110 judges which is given priority, the communication ability or the power saving in the display terminals D1, D2.

This judgment is possible, for example, by either one of following 1) or 2).

1) At a time that the switching judgment unit 110 receives a notification of generation start or generation completion of the transmission image data from the transmission image generating unit 108, the switching judgment unit 110 inquires of the update detection unit 107 whether or not a subsequent screen update is scheduled (whether or not the update information exist in the image buffer 106). As a result of the inquiry, if it is confirmed that the subsequent screen update is not scheduled, the switching judgment unit 110 decides to make the radio communication unit 135 of the display terminal D1 or D2 shift into the power save mode. This is because it can be judged that the data transfer from the image generating apparatus M to the display terminals D1, D2 does not occur for a while.

2) At a time that the switching judgment unit 110 receives the notification of the generation start of the transmission image data from the transmission image generating unit 108, the switching judgment unit 110 inquires of the update detection unit 107 whether or not the subsequent screen update is scheduled. As a result of the inquiry, if it is confirmed that the subsequent screen update is not scheduled, the switching judgment unit 110 orders the timer 109 to start time keeping.

At a time that the switching judgment unit 110 receives the notification of the generation completion of the transmission image data, the switching judgment unit 110 judges whether or not to make the display terminal D1 or D2 shift into the power save mode. On this occasion, if the time kept by the timer 109 passes over a predetermined period and it is confirmed that the subsequent screen update is not scheduled, the switching judgment unit 110 decides to make the display terminal D1 or D2 into the power save mode. The schedule of the screen update can be confirmed by the inquiry to the update detection unit 107.

Incidentally, after the start of the time keeping by the timer 109, if the switching judgment unit 110 confirms that the subsequent update screen exists or if the generation start of the transmission image data is notified, the switching judgment unit 110 orders the timer 109 to stop the time keeping.

The message generating unit 111 generates a message to order switching of the mode according to the judgment of the switching judgment unit 110. The message generating unit 111 generates a message (power-saving mode shift message) for switching the radio communication units 135 of the display terminals D1, D2 from in the active mode into the power save mode.

The communication unit 112 transmits the message generated by the message generating unit 111 and the transmission image data generated by the transmission image generating unit 108 to the display terminals D1, D2 via the access point A. After the transmission of the transmission image data generated by the transmission image generating unit 108, the communication unit 112 transmits the message generated by the message generating unit 111. This message means ending information indicating a termination of the consecutively occurring screen updates.

The session manager 113 controls sessions between the image generating apparatus M and the display terminals D1, D2. For example, the session manger 113 designates one of the display terminals D1, D2 as a transmission destination of the message from the image generating apparatus M.

In the session information storage unit 114, information of the session is stored. This session information includes destination information (for example, user identification information) of the display terminals D1, D2 establishing the sessions between the image generating apparatus M, information indicating presence/absence of session use, and information indicating which of TCP and UDP is used for transmission control.

When the image generating apparatus M and the display terminals D1, D2 establish the sessions, the access point A also completes negotiations with the display terminals D1, D2, and the radio communication is possible. Since there is a possibility that numerous display terminals D1, D2 establish sessions to one image generating apparatus M, in the session information storage unit 114 is stored information for identifying a destination of a packet transmitted from the image generating apparatus M.

### (Details of Power-Saving State Shift Message)

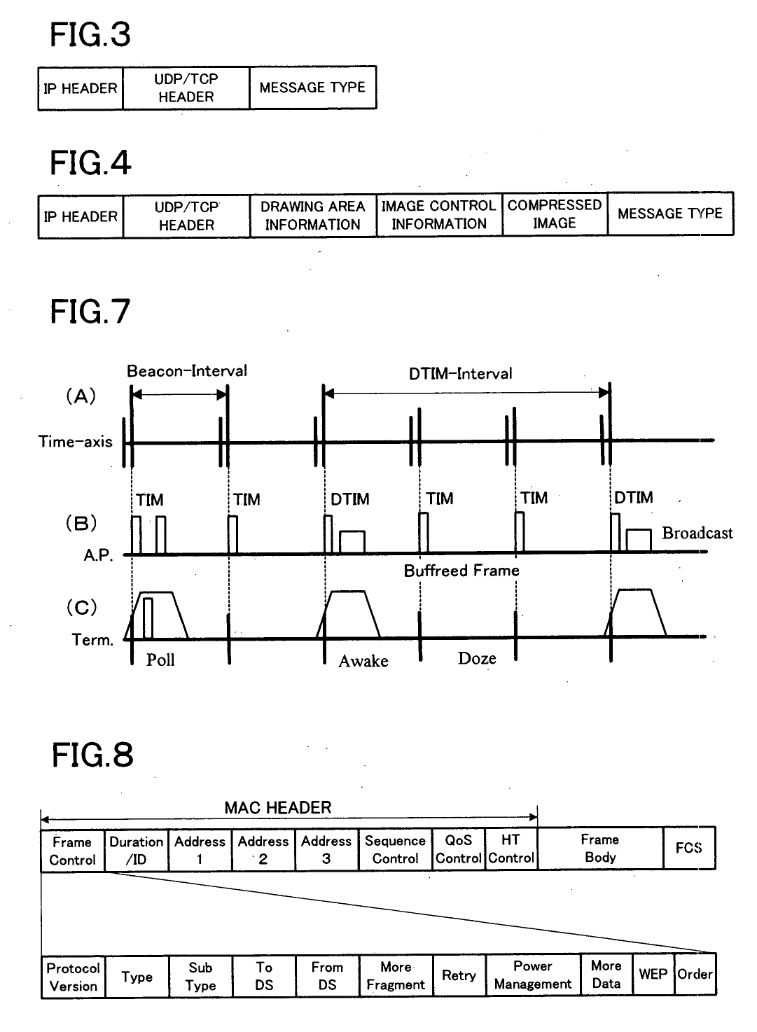

FIG. 3 is a schematic diagram showing an example of the power-saving state shift message. This power-saving sate shift message is constituted with an IP header, an UDP/TCP header, a message type and so forth.

The IP header is an IP (Internet Protocol) header as control information on a network layer. The UDP/TCP header is control information which differs depending on whether transmission control uses UDP or TCP as the control information on a transport layer.

In the message type, there is set information (power-saving state shift identification information) for identifying a message as a power-saving state shift message. When a communication packet including this message type is received, the display terminals D1, D2 switch the radio communication units 135 into the power-saving state (power save mode).

FIG. 4 is a schematic diagram showing another example of the power-saving state shift message. This power-saving state shift message is constituted with an IP header, an UDP/TCP header, drawing area information, image control information, a compressed image and a message type.

The power-saving state shift message means an end of screen updates consecutively occurs in the image generating apparatus M. Accordingly, if a transmission condition of the power-saving state shift message is fulfilled immediately after the generation of the transmission image of the last update screen, the compressed image (transmission image) and the power-saving state shift message can be combined as in FIG. 4.

As stated above, there exist the IP header as the control information on the network layer and the UDP/TCP header as the control information on the transport layer.

The drawing area information includes information of coordinates (x, y) for designating a drawing place of the compressed image and a planar dimension (vertical and horizontal lengths).

The image control information is information necessary for decoding the image such as a quantization parameter and Huffman table information. In the case of JPEG (Joint Photographic Experts Group), the image control information means from SOI (Start of Image) to before SOS (Start of Scan: compressed image information).

The compressed image is difference image information having been subjected to still image compression in the image generating apparatus M, and is decoded to the original difference image information by using the above-described image control information for decoding. In the case of JPEG, the compressed image means from SOS to EOI (End of Image).

As shown in FIG. 4, the message type is added after the compressed image. As a result, the display terminals D1, D2 are notified that the image in the message is the end of the screen updates continuously occurring in the image generating apparatus M. Thereby such notification can be done more effectively than by creating a new message packet separately and transmitting it.

### (Details of Access Point A)

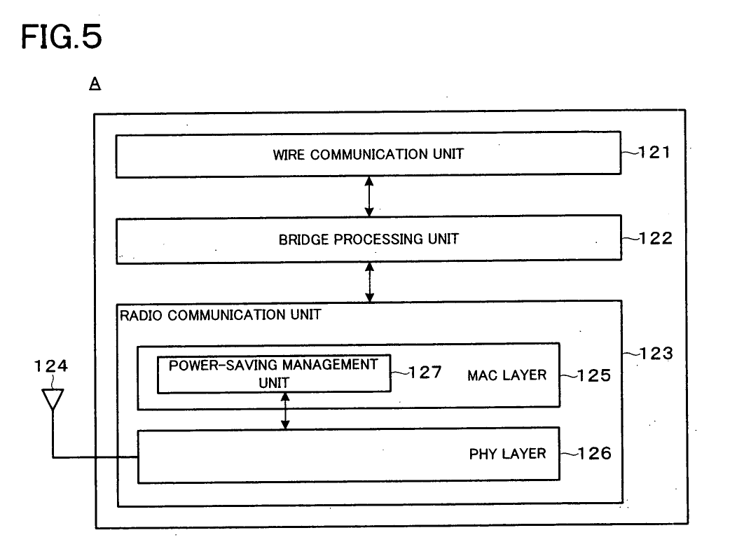

FIG. 5 is a block diagram showing an internal configuration of the access point A. The access point A has a wire communication unit 121, a bridge processing unit 122, a radio communication unit 123 and an antenna 124.

The wire communication unit 121 communicates with the communication unit 112 of the image generating apparatus M by wire in conformity with IEEE802.3, for example.

The bridge processing unit 122 exchanges information between the wire communication unit 121 and the radio communication unit 123. Data inputted via the wire communication unit 121 is filtered by the bridge processing unit 122 and thereafter delivered to the radio communication unit 123. Data inputted via the radio communication unit 123 is filtered by the bridge processing unit 122 and thereafter delivered to the wire communication unit 121.

The radio communication unit 123 communicates with the display terminals D1, D2 by radio in conformity with IEEE802.11 (a/b/g and the like), for example. The antenna 124 is connected to the radio communication unit 123 and transmits/receives a wireless packet. The radio communication unit 123 is divided into an MAC (Medium Access Control) layer 125 and a PHY (PHYsical) layer 126. The MAC layer 125 has a power-saving management part 127.

The power-saving management part 127 confirms which of the active mode or the power save mode the display terminals D1, D2 are in. By analyzing power management information (power management field) of a MAC header of a MAC frame received from the display terminals D1, D2, modes of the display terminals D1, D2 can be confirmed.

If the wire communication unit 121 receives the difference image information, the power-saving management part 127 confirms the power states of the radio communication units 135 of the display terminals D1, D2. If the display terminals D1, D2 are in the active modes, data are immediately transmitted from the radio communication unit 123. On the other hand, if the display terminals D1, D2 are in the power save modes, the radio communication unit 123 buffers data addressed to the display terminals D1, D2 and notifies the display terminals D1, D2 that the data exist. This notification is possible by the control information (power management information) in a beacon frame transmitted periodically from the radio communication unit 123.

### (Details of Display Terminals D1, D2)

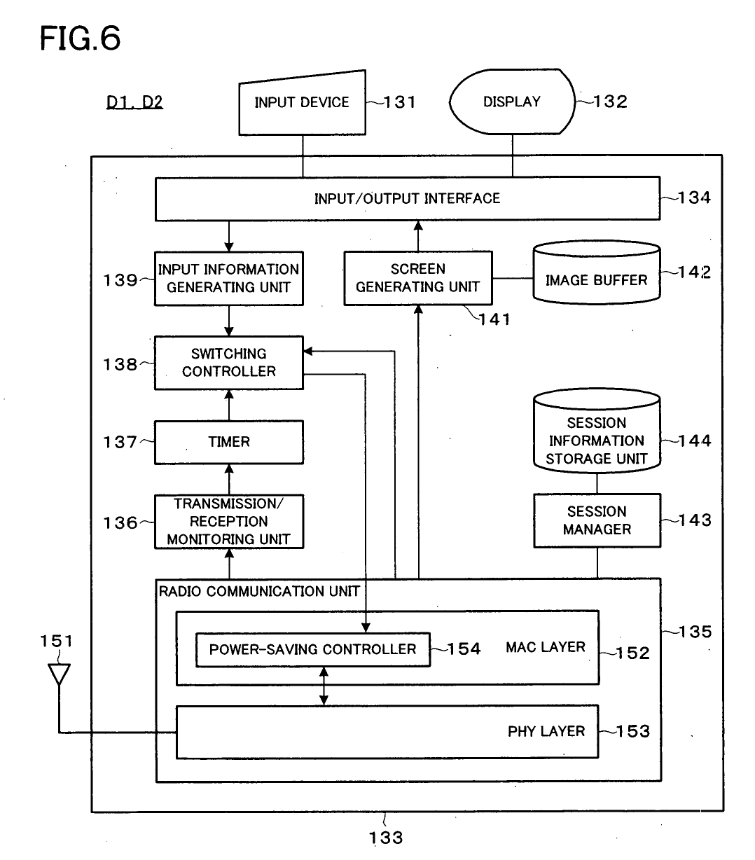

FIG. 6 is a block diagram showing an internal configuration of display terminals D1, D2. As shown in FIG. 6, each of the display terminals D1, D2 includes an input device 131, a display 132, and a terminal main body 133. The terminal main body 133 includes an input/output interface 134, a radio communication unit 135, a transmission/reception monitoring unit 136, a timer 137, a switching controller 138, an input information generating unit 139, an image generating unit 141, an image buffer 142, a session manager 143, and a session information storage unit 144.

The input device 131 is an information input means such as a digitizer using pen input, and for example, can perform a moving operation to a cursor displayed on a screen of the display 132. The display 132 is a display means such as a liquid crystal display device. The input/output interface 134 is an interface for the input device 131 and the display 132.

The radio communication unit 135 has an antenna 151 for transmitting/receiving a physical frame by radio. The radio communication unit 135 is divided into a MAC layer 152 and a PHY layer 153. In the MAC layer 152, a power-saving controller 154 is disposed. The radio communication unit 135 communicates in conformity with a standard such as IEEE802.11 (2 Mbps), IEEE802.11b (11 Mbps), IEEE802.11g (54 Mbps), and IEE802.11a (54 Mbps).

The power saving controller 154 controls supply of electric power to a transmission/reception system of the radio communication unit 135 in correspondence with a mode of the radio communication unit 135. As operation modes of the radio communication unit 135, there exist two kinds of an active mode (constantly communicable state) and a power save mode (state in which an awake state and a doze state are periodically repeated). In the power save mode, the electric power is supplied to the transmission/reception system of the radio communication unit 135 so that the radio communication unit 135 shifts into an awake (communicable) state, in every cycle of a beacon frame reception from the access point A. Meanwhile, in the other period, the radio communication unit 135 shifts into a doze (incommunicable) state in which the radio communication unit 135 operates with a minimum electric power. If the radio communication unit 135 analyzes the beacon frame received from the access point A and recognizes that the data to the radio communication unit 135 are stored, the radio communication unit 135 transmits a transmission request frame to urge a frame transmission to the radio communication unit 135.

FIG. 7 shows an example of operating states of the access point A and radio terminals (display terminals D1, D2) during the power save mode in conformity with the IEEE802.11 standard. Shown as (A), (B), (C) of FIG. 7 are a time axis, the operating state of the access point A, and the operating state of the display terminals D1, D2, respectively.

The access point A creates the beacon frame and broadcast it toward a radio network (BSS: Basic Service Set) under local management in every beacon cycle. In the beacon frame of the access point A there exists an identification field called TIM (Traffic Indication Message). If a MAC data frame addressed to the display terminals D1, D2 exists, a corresponding bit of TIM is made valid and the display terminals D1, D2 are notified thereof. The access point A releases the stored multicast/broadcast frame from the buffer and transmits it in every time interval called DTIM (Delivery Traffic Indication Message).

The display terminals D1, D2 supply electric power to the transmission/reception systems of the radio communication units, shift into the awake states, and then receive the beacon frames, in every designated beacon reception period. If frames addressed to the display terminals D1, D2 are stored in the access point A, the display terminals D1, D2 transmit transmission request (PS-Poll: Power Save Poll) frames and maintain the awake states until reception of the all frames addressed to the display terminals D1, D2 being responses to the transmission request frames is completed. Incidentally, the display terminals D1, D2 shift from in the dose states into the awake states also in every DIM period, to receive the multicast/broadcast frames.

The radio communication unit 135 receives a radio signal from the access point A by the antenna 151. The radio communication unit 135 demodulates the received radio signal to generate a packet and makes delivery to the switching controller 138 or the image generating unit 141 in correspondence with the message type of the packet. If the packet includes the power-saving state shift message (see FIG. 3, FIG. 4), this message is delivered to the switching controller 138. If the packet is the data packet in the screen transfer system 10, the compressed image extracted from that packet is delivered to the screen generating unit 141.

The screen generating unit 141 expands the delivered compressed image and writes the expanded image into the designated drawing place of the image buffer 142. In other words, the screen generating unit 141 expands the compressed image transmitted from the image generating apparatus M and received by the radio communication unit 135, to display the expanded image in a designated place of the display 132.

The image buffer 142 is a video memory for drawing.

The transmission/reception monitoring unit 136 manages a communication state of the radio communication unit 135. In other words, the transmission/reception monitoring unit 136 monitors existence/non-existence of the communication in the radio communication unit 135.

The timer 137 measures duration of the incommunicable state in the radio communication unit 135. When discommunication in the radio communication unit 135 is monitored, the transmission/reception monitoring unit 136 orders start of time keeping at the timer 137. When communication in the radio communication unit 135 is monitored, the transmission/reception unit 136 orders termination of the time keeping at the timer 137.

The switching controller 138 switches the power sate (mode) of the radio communication unit 135. The switching controller 138 switches the mode of the radio communication unit 135 from the active mode to the power save mode when the time measured by the timer 137 reaches a predetermined period. Further, when the switching controller 138 is provided with the power-saving mode shift message from the radio communication unit 135, the switching controller 138 switches the mode of the radio communication unit 135 from the active mode to the power save mode via the power-saving controller 154.

In the MAC header of the MAC frame transmitted via the radio communication units 135, there exists information (power management information) indicating the power states of the display terminals D1, D2. By using this information, it becomes possible to notify the access point A whether the mode is the active mode or the power save mode.

Methods of notification to the access point A differ in correspondence with which of TCP or UDP a transport layer protocol of the radio communication unit 135 is. In order to receive the difference image information from the image generating apparatus M, the display terminal D1 or D2 can use the TCP (Transmission Control Protocol) or the UDP (User Datagram Protocol) as the transport layer protocol.

The TCP is a bi-directional transport layer protocol. Accordingly, in response to data (screen information or power-saving state shift message) transmission from the image generating apparatus M, acknowledgement (ACK) frames are sent back from the display terminals D1, D2. In this case, the state of the radio communication unit 135 can be notified to the access point A by using the acknowledgement frame in the transport layer.

On the other hand, in the case of a uni-directional transport layer protocol such as UDP, the acknowledgment frame does not exist. Therefore, it is desirable to transmit any frame to notify the access point A of the state of the radio communication unit 135. In addition to this, it can also be considered to notify the image generating apparatus M and the access point A separately that the radio communication unit 135 is in the power save mode. In other words, the image generating apparatus M is notified that the radio communication unit 135 has shifted into the power save mode. In addition, the access point A is notified that the radio communication unit 135 is in the power save mode.

FIG. 8 is a schematic diagram showing a configuration of the MAC frame. In a frame control field for storing the control information, there exists a power management bit, and by designation by this bit, it is notified whether the radio communication units 135 of the display terminals D1, D2 are in the active modes or in the power save modes.

### (Operation of Screen Transfer System 10)

Hereinafter, an operation of the screen transfer system 10 will be described.

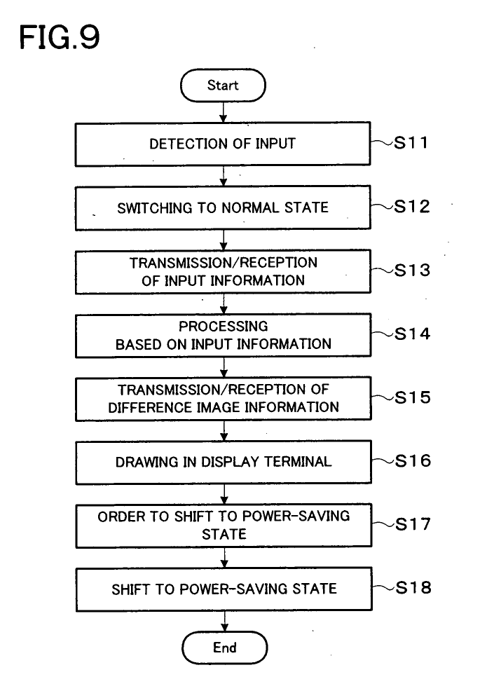

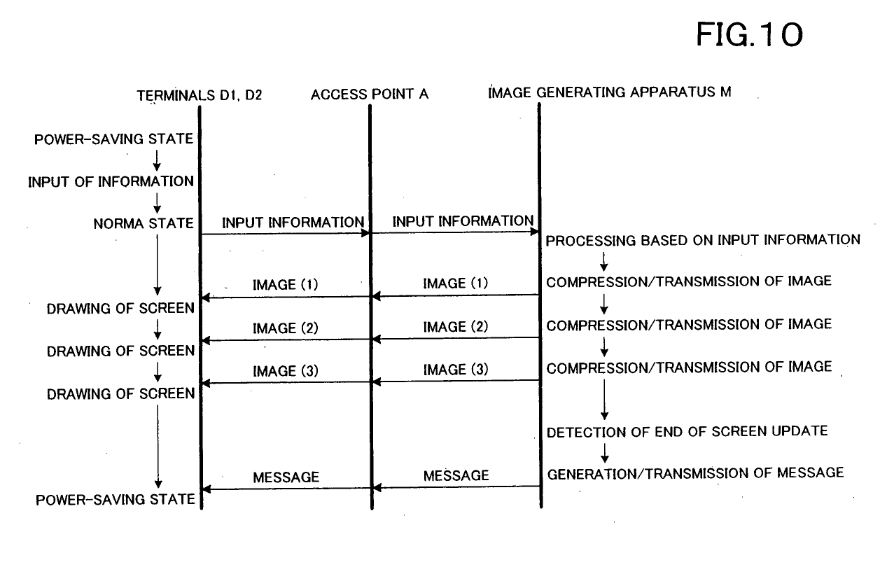

FIG. 9 is a flowchart showing an outline of operating procedures of the screen transfer system 10. FIG. 10 is a sequence diagram showing an example of a flow of communication in the screen transfer system 10.

Here, there will be described a case in which a screen transfer application such as VNC (Virtual Network Computing) is used between, for example, the display terminal D1 of the display terminals D1, D2 and the image generating apparatus M so that screen information of the image generating apparatus M is transferred to the display terminal D1.

Assume that the display terminal D1 usually makes the radio communication unit 135 operate in the power save mode. As described above, the data frame addressed to the display terminal D1 operating in the power save mode is buffered by the access point A. The access point A notifies that the data addressed to the display terminal D1 are stored, by a periodical beacon frame. When the display terminal D1 recognizes by the beacon frame that the data addressed to the display terminal D1 are stored, the display terminal D1 transmits a PS-Poll (Power Save Poll) frame to request the access point A to release the data frame. Therefore, during the operation in the power save mode, the data are not received by the display terminal D1 in real time and the response performance will decrease.

### (1) Detection of Input (Step S11)

The display terminal D1 detects an input to the input device 131 such as a digitizer and obtains input information such as a position coordinate.

### (2) Switching to Normal State (Step S12)

Before the input information is transmitted from the display terminal D1 to the image generating apparatus M, the power state of the radio communication unit 135 is switched from the power save mode (power-saving state) to the active mode (normal state).

### (3) Transmission/Reception of Input Information (Step S13)

The input information is transmitted from the display terminal D1 to the image generating apparatus M via the access point A. On this occasion, the input information is transmitted as a PPDU (PLCP Protocol Data Unit). The PPDU is a transmission unit of a physical layer in a wireless LAN and is made of a MAC frame to which a physical header, a physical preamble, a trailer and the like are added.

A power management bit of a MAC header part of this MAC frame indicates which of the active mode and the power save mode the display terminal D1 is in. In this case, the power management information indicates that the display terminal D1 is in the active mode. Thus, the access point A confirms that the radio communication unit 135 of the display terminal D1 is in the active mode and then transmits the data frame addressed to the display terminal D1 without buffering.

### (4) Processing Based on Input Information (Step S14)

When the image generating apparatus M receives the input information from the display terminal D1, the image generating apparatus M regards the input information as an event such as a mouse operation (click, drag and drop) on a window system and performs an application program based on the input information. On that occasion, an update of the screen such as moving of the cursor or activation of a new window may occur. Here, assume that three screen updates have occurred.

The event acquisition unit 104 of the image generating apparatus M outputs the update information (update image information or drawing area information) obtained from the OS to the update information storage unit 105.

### (5) Transmission/Reception of Difference Image Information (Step S15)

The update detection unit 107 acquires the update image via the update information storage unit 105 and makes the image buffer 106 store the image sequentially. Every time that the update information is inputted to the update information storage unit 105, the update detection unit 107 obtains the difference (difference image information) from a previous update image in the image buffer 106, and transmits it to the transmission image generating unit 108.

The transmission image generating unit 108 subjects the inputted difference image to still image compression to generate a compressed image (transmission image data). The transmission image generating unit 108 picks up destination information from the session manager 113, generates a packet for compressed image transmission, and then delivers the packet to the communication unit 112. The communication unit 112 transmits the delivered packet (difference image information U) to the network N.

Incidentally, the updates of the screen consecutively occur. In compliance with a band of the usable network N, the screen information to be transmitted is selected from a plurality of update images (frame omission), and thereafter the still image compression is performed.

### (6) Drawing in Display Terminal D1 (Step S16)

The image is drawn in the display terminal D1 as follows. The difference image information U sent from the image generating apparatus M to the network N is transmitted from the access point A to a radio propagation path. In the display terminal D1, the difference image information U transmitted from the access point A is received by the antenna 151 and decoded to the compressed image in the radio communication unit 135, and then delivered to the screen generating unit 141. By expanding the delivered compressed image and writing the expanded image into the image buffer 142, the screen generating unit 141 draws the difference image in a designated area.

### (7) Shift Order to Power-Saving State (Step S17)

If the update of the screen does not occur for a predetermined period, the power-saving mode shift message is transmitted. In this case, the image generating apparatus M transmits the last of a series of screen update information to the display terminal D1, and thereafter generates the power-saving state shift message and transmits it to the display terminal D1.

After the difference image is transmitted to the display terminal D1 via the communication unit 112, the update detection unit 107 inspects the update information storage unit 105 to confirm whether or not the update image exists. Immediately after the generation of the transmission image, generation of the transmission image is notified from the transmission image generating unit 108 to the switching judgment unit 110, and the switching judgment unit 110 confirms whether or not a subsequent screen update exists via the update detection unit 107.

The update detection unit 107 retrieves the update information from a forefront of the update information storage unit 105 which stores the information in first-in-first-out manner. Therefore, if the update information (update image information or drawing area information) does not exist in the forefront of the update information storage unit 105, the subsequent screen update does not exist. In this case, the power-saving state shift message is transmitted to the display device D1. Also, information of displaying screen in the frame buffer and the update image information in the image buffer 106 can be compared and, if there is no difference therebetween, it can be judged that the update of the screen does not exist.

If the subsequent screen update does not exist, the message generating unit 111 generates the power-saving state shift message to the display terminal D1 and thereafter transmits the message via the communication unit 112.

### (8) Shift to Power-Saving State (Step S18)

The display terminal D1 receives the update screen from the image generating apparatus M in a state that the radio communication unit 135 is in the active mode. When the display terminal D1 receives the power-saving state shift message from the image generating apparatus M, the display terminal D1 makes the radio communication unit 135 into the power save mode via the switching controller 138. When the display terminal D1 is not transmitting/receiving data to/from the image generating apparatus M for a predetermined period, the display terminal D1 makes the radio communication unit 135 shift into the power save mode via the transmission/reception monitoring unit 136.

The display terminal D1 notifies the access point A that the radio communication unit 135 is in the power save mode. For this notification, there can be used an acknowledgement frame of the TCP, for example.

### (Operating Procedures of Display Terminals D1, D2)

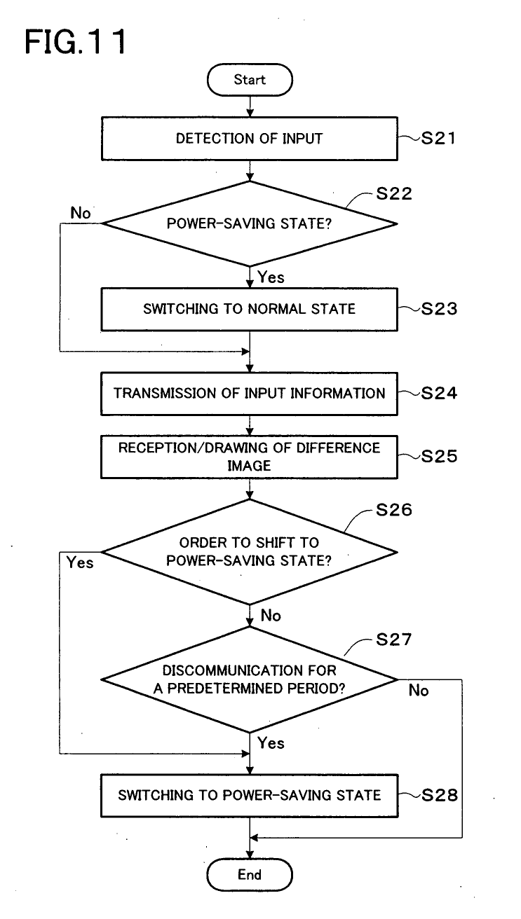

FIG. 11 is a flowchart showing an example of operating procedures in the display terminals D1, D2.

When the input at the input device 131 is detected (step S21), in the case that the radio communication unit 135 is in the power-saving state, the radio communication unit 135 is switched into the normal state (steps S22, S23).

The input information is transmitted from the radio communication unit 135 (step S24). In correspondence therewith, the difference image information transmitted from the image generating apparatus M is received by the radio communication unit 135, and based on this difference image information, the image is drawn on the display 132 (step S25).

By the transmission of the power-saving state shift message from the image generating apparatus M or the radio communication unit 135 doesn't transmit any packet for the predetermined period, the radio communication unit 135 shifts from in the normal state into the power-saving state.

### (Operating Procedures in Image Generating Apparatus M)

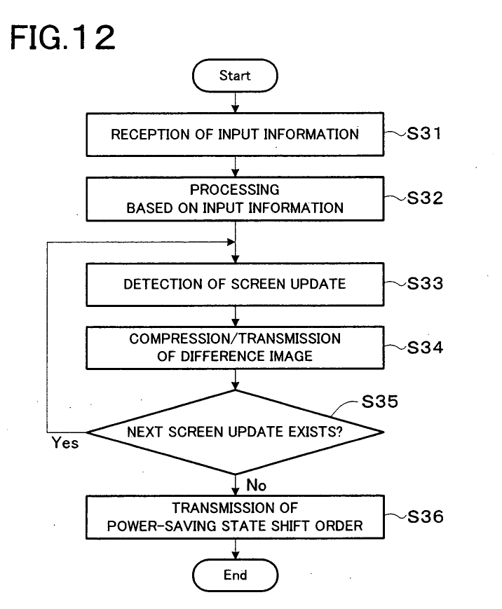

FIG. 12 is a flowchart showing an example of operating procedures in the image generating apparatus M.

Based on the input information received from the display terminals D1, D2, the application program is performed and the screen is updated (steps S31 to S33). The difference image information corresponding to the update of the screen is generated, compressed and transmitted (step S34). If the next screen update is not detected at a time of this transmission, the power-saving state shift message is transmitted from the image generating apparatus M to the display terminals D1, D2 (steps S35, S36).

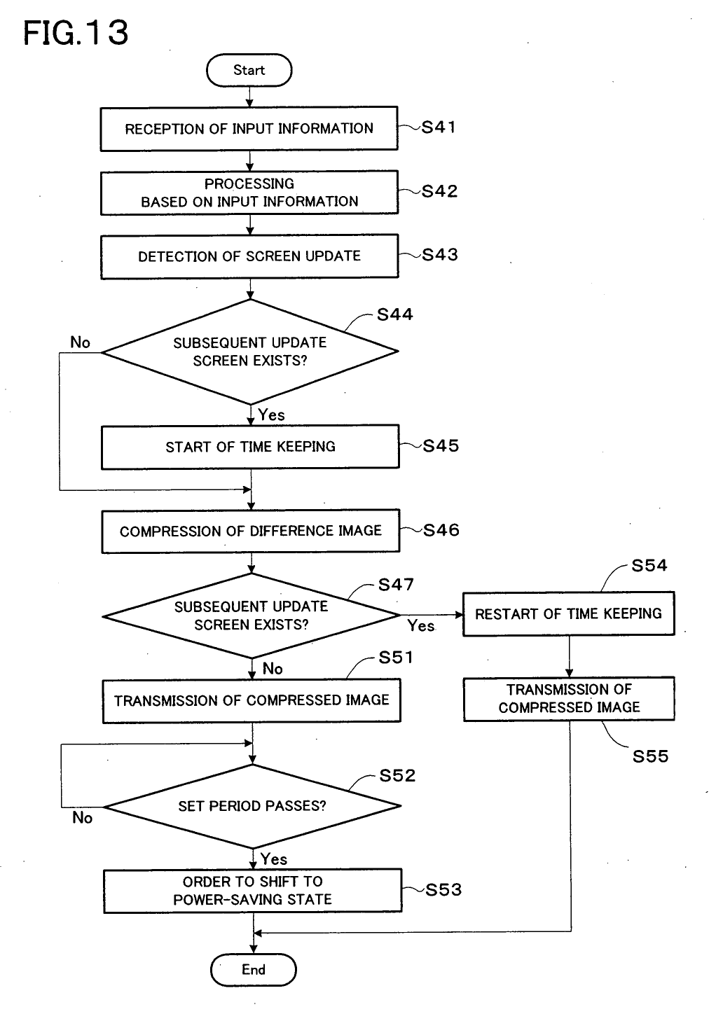

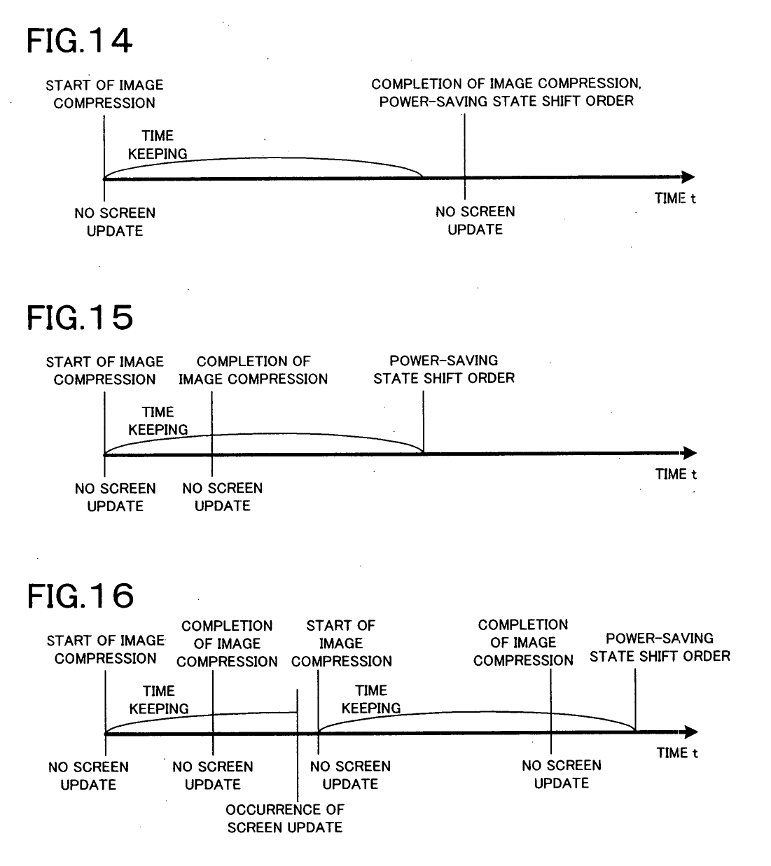

FIG. 13 is a flowchart showing another example of the operating procedures in the image generating apparatus M. FIG. 14 to FIG. 16 are timing charts showing examples of timings of processings in the image generating apparatus M. Here, the image generating apparatus M confirms existence/non-existence of the screen update via the update detection unit 107 immediately after the generation of the transmission image and just before the generation of the next transmission image. This is to prevent the display terminals D1, D2 from shifting unnecessarily into the power save modes.

The steps S41 and S342 are not substantially different from the steps 31 and S32 of FIG. 12. If it is confirmed that the subsequent screen update does not exist via the update detection unit 107 just before the image generating apparatus M generates the transmission image from the update screen (just before the compression), the timer 109 is set and time keeping is started (steps S44, S45).

Immediately after the generation of the image to be transmitted, existence/non-existence of the subsequent screen update is confirmed by the update detection unit 107 (steps S46, S47). If it is confirmed that the subsequent screen update does not exist, when time measured by the timer 109 reaches a predetermined period, a message to order shift to the power save mode is transmitted to the display terminals D1, D2 (steps S52, S 53).

If it is confirmed that the subsequent screen update exists immediately after the generation of the image to be transmitted, the timer 109 is reset to start time keeping from “0 (zero)” (step S54).

Incidentally, the compressed image is transmitted appropriately (steps S51, S55).

In FIG. 14, since the subsequent screen update does not exist at a time of generation start of the transmission image, the timer 109 is set. At a time of completion of the generation of the transmission image, the subsequent screen update does not exist and the time measured by the timer 109 reaches the predetermined period. Accordingly, after the transmission of the transmission image, the power-saving state shift message is transmitted.

In FIG. 15, during the time keeping by the timer 109, the transmission image is generated and transmitted to the display terminals D1, D2. The power-saving state shift message is transmitted after the time measured by the timer 109 reaches the predetermined period.

In FIG. 16, while the time keeping by the timer 109 continues, a new screen update occurs, and the timer 109 is once reset. After the time started to be measured again by the timer 109 reaches the predetermined period, the power-saving state shift message is transmitted.

### (Operating Procedures in Access Point A)

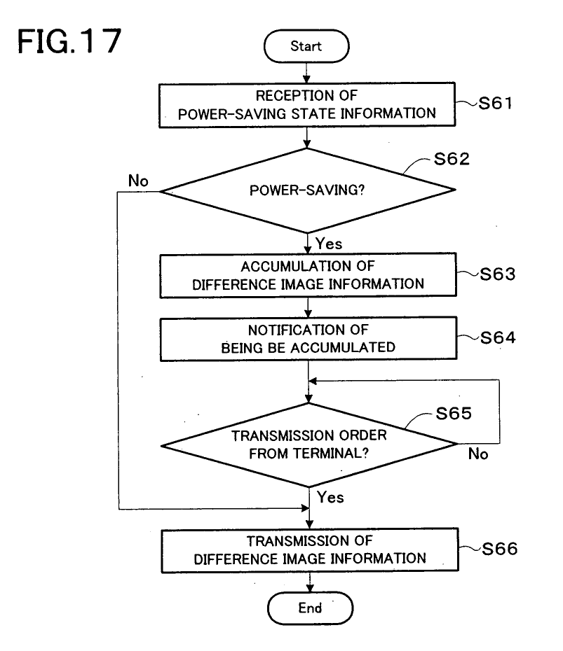

FIG. 17 is a flowchart showing an example of operating procedures in an access point A.

When the power state information received from the display terminals D1, D2 indicates the power save mode (power-saving state), the difference image information received from the image generating apparatus M is stored (buffered) (steps S61 to S63). During this accumulation, the display terminals D1, D2 are notified that the difference image information is being stored, and by transmission orders from the display terminals D1, D2, the stored difference image information is transmitted (steps S64 to S66).

In this embodiment, the states of the radio communication processing units 135 of the display terminals D1, D2 are switched to the power-saving states and the normal states appropriately, in correspondence with the update state of the screen. As a result, power saving can be enhanced while responsiveness being maintained. Additionally, by capturing the end of the screen updates occurring consecutively, unnecessary shift to the power-saving state is prevented. Compared with the case of procedures in which the state shifts to the power-saving state after a predetermined period since occurrence of the last transmission/reception processing, it becomes possible to apply the power-saving state more effectively.

### Other Embodiments

Additional advantages and modifications will readily occur to those skilled in the art. Therefore, the invention in its broader aspects is not limited to the specific details and representative embodiments shown and described herein. Accordingly, various modifications may be made without departing from the spirit of scope of the general inventive concept as defined by the appended claims and their equivalents.

What is claimed is:

1. An image generating apparatus, comprising:
an image generating unit configured to generate and update an image to be displayed by a remote display terminal, the remote display terminal including a radio communication unit whose power state is switchable;
an update detection unit configured to detect an update of the image by the image generating unit;
a first transmission control unit configured to control transmission of the image,whose update is detected by the update detection unit, toward the radio communication unit of the remote display terminal;
a switching decision unit configured to decide switching of the power state of the radio communication unit if the update detection unit does not detect the update of the image for a predetermined period;
a message generating unit configured to generate a message to order switching of the power state of the radio communication unit of the remote display terminal based on a decision by the switching decision unit; and
a second transmission control unit configured to control transmission of the message generated by the message generating unit to the radio communication unit of the remote display terminal.

2. The image generating apparatus according to claim 1, wherein the switching decision unit includes:
a timer;
a first timer control part configured to make the timer start time keeping if the update detection unit does not detect the update of the image;
a second timer control part configured to make the timer stop the time keeping when the update detection unit detects the update of the image; and
a decision part configured to decide the switching of the power state of the radio communication unit based on the time keeping for a predetermined period by the timer.

3. The image generating apparatus according to claim 1, further comprising: a difference generating unit configured to generate difference information between before and after the update of the image detected by the update detection unit,
wherein the first transmission control unit controls transmission of difference information generated by the difference generating unit to the radio communication unit of the remote display terminal.

4. A communication system having a remote display terminal and an image generating apparatus,
the remote display terminal, comprising:
an input unit configured to input information;
a radio communication unit having a transmission part configured to transmit information inputted by the input unit to the apparatus and a receiving part configured to receive an image from the apparatus, a power state of the radio communication unit configured to be switchable;
a display unit configured to display the image received by the receiving part; and
a first switching unit configured to switch the power state of the radio communication unit based on an input by the input unit, and
the apparatus, comprising:
an image generating unit configured to generate and update an image to be displayed by the remote display terminal;
an update detection unit configured to detect an update of the image by the image generating unit;
a first transmission control unit configured to control transmission of the image,whose update is detected by the update detection unit, toward the radio communication unit of the remote display terminal;
a switching decision unit configured to decide switching of the power sate of the radio communication unit if the update detection unit does not detect the update of the image for a predetermined period;
a message generating unit configured to generate a message to order the switching of the power state of the radio communication unit of the remote display terminal based on a decision by the switching decision unit; and
a second transmission control unit configured to control transmission of the message generated by the message generating unit to the radio communication unit of the remote display terminal.

5. The communication system according to claim 4, wherein the switching decision unit includes:
a timer;
a first timer control part configured to make the timer start time keeping if the update detection unit does not detect the update of the image;
a second timer control part configured to make the timer stop the time keeping when the update detection unit detects the update of the image; and
a decision part configured to decide the switching of the power state of the radio communication unit based on the time keeping for a predetermined period by the timer.

6. The communication system according to claim 4,
wherein the apparatus further comprises a difference generating unit configured to generate difference information between before and after the update of the image detected by the update detection unit, and
the first transmission control unit controls transmission of difference information generated by the difference generating unit to the radio communication unit of the remote display terminal.

7. The communication system according to claim 4, wherein the remote display terminal further comprises a second switching unit configured to switch the power state of the radio communication unit of the remote display terminal based on discommunication of the radio communication unit for a predetermined period.

8. The communication system according to claim 4, wherein the remote display terminal further comprises a second switching unit configured to switch the power state of the radio communication unit of the remote display terminal based on a switching order of the power state from the apparatus.

9. A communication method, comprising:
detecting an update of an image generated by an image generating unit;
transmitting the image whose update is detected to a radio communication unit of a remote display terminal;
deciding switching of a power state of the radio communication unit of the remote display terminal if the update of the image is not detected for a predetermined period;
generating a message to order the switching of the power state of the radio communication unit based on the decision; and
transmitting the generated message to the radio communication unit.
